(19) United States
(12) Patent Application Publication
(10) Pub. No.: US 2013/0135247 A1
(43) Pub. Date: May 30, 2013

(54) TOUCH SENSING APPARATUS

(71) Applicants: Jun Kyung NA, Anyang (KR); Yong Il Kwon, Suwon (KR); Tah Joon Park, Suwon (KR); Jae Hyouck Choi, Seongnam (KR); Il Kwon Chung, Seongnam (KR)

(72) Inventors: Jun Kyung NA, Anyang (KR); Yong Il Kwon, Suwon (KR); Tah Joon Park, Suwon (KR); Jae Hyouck Choi, Seongnam (KR); Il Kwon Chung, Seongnam (KR)

(73) Assignee: SAMSUNG ELECTRO-MECHANICS CO., LTD., Suwon (KR)

(21) Appl. No.: 13/406,886

(22) Filed: Feb. 28, 2012

(30) Foreign Application Priority Data
Nov. 24, 2011 (KR) 10-2011-0123482

(51) Int. Cl. G06F 3/044

(52) U.S. Cl. 345/174

(57) ABSTRACT

There is provided a touch sensing apparatus including a panel unit in which a plurality of electrodes intersecting with each other are disposed; and a control unit sensing changes in capacitance generated in regions in which respective electrodes, among the plurality of intersecting electrodes, intersect, wherein the panel unit includes a first region in which the plurality of electrodes are disposed with a first interval therebetween, and a second region in which the plurality of electrodes are disposed with a second interval therebetween, and the control unit senses a fingerprint touching the second region based on a change in capacitance generated therein.

### CROSS-REFERENCE TO RELATED APPLICATIONS

This application claims the priority of Korean Patent Application No. 10-2011-0123482 filed on Nov. 24, 2011, in the Korean Intellectual Property Office, the disclosure of which is incorporated herein by reference.

### BACKGROUND OF THE INVENTION

1. Field of the Invention

The present invention relates to a touch sensing apparatus having a fingerprint sensing function, and more particularly, to a touch sensing apparatus capable of providing an enhanced security function.

2. Description of the Related Art

Touch sensing apparatuses such as a touch screen, a touch pad, and the like, are apparatuses attached to display apparatuses and providing users with intuitive input methods, and have recently been applied to various electronic apparatuses such as cellular phones, personal digital assistants (PDAs), navigation devices, and the like. In particular, as demand for smart phones has recently increased, touch screens have increasingly been employed as touch sensing apparatuses capable of providing various input methods in a limited form factor.

Touch screens applied to portable electronic apparatuses may be classified into resistive type touch screens and capacitive type touch screens according to a touch sensing method. Capacitive type touch screens can have advantageously long lifespans and various input methods and touch movements can be easily implemented therein, and thus, applications therefor have been increasing. In particular, as it is easier to implement a multi-touch interface in capacitive type touch screens rather than resistive type touch screens, capacitive type touch screens have a wide range of applications in electronic apparatuses such as smart phones.

Touch screen apparatuses, as input apparatuses, have applications in the implementation of security functions in mobile apparatuses such as smart phones. For example, a password may be easily set and input through a touch screen apparatus, or a pattern input method, which may not be easily implemented using a general keypad, can be provided by the touch screen apparatus. However, password and pattern recognition functions may be exposed to third parties, thus neutralizing the security function. Additionally, even in the case that a fingerprint recognition sensor is additionally included in a smart phone, it is spatially inefficient in terms of smart phone characteristics which require the implementation of various functions in a limited form factor.

### SUMMARY OF THE INVENTION

To solve the above-described problem, the present invention implements a fingerprint recognition sensor in a region of a capacitive type touch sensing apparatus determining a touch using a change in capacitance by differentiating intervals between electrodes or densities of electrodes. Thus, since it is unnecessary to provide the fingerprint recognition sensor in separate hardware, an aspect of the present invention provides a touch sensing apparatus capable of providing an enhanced security function in a mobile apparatus having a limited form factor.

According to an aspect of the present invention, there is provided a touch sensing apparatus including: a panel unit in which a plurality of electrodes intersecting with each other are disposed; and a control unit sensing changes in capacitance generated in regions in which respective electrodes, among the plurality of intersecting electrodes, intersect, wherein the panel unit includes a first region in which the plurality of electrodes are disposed with a first interval therebetween, and a second region in which the plurality of electrodes are disposed with a second interval therebetween, and the control unit senses a fingerprint touching the second region based on a change in capacitance generated therein.

The panel unit may include a plurality of first electrodes extending in a first axial direction and electrically separating from each other; and a plurality of second electrodes extending in a second axial direction, intersecting with the first electrodes extending in the first axial direction, and electrically separated from each other.

The control unit may sequentially apply a driving signal to the plurality of individual first electrodes, and sense the changes in capacitance generated from the second electrodes intersecting with the first electrodes to which the driving signal is applied.

Intervals between the plurality of first electrodes in the second region of the panel unit may be smaller than intervals between the plurality of first electrodes in the first region thereof.

Intervals between the plurality of second electrodes in the second region of the panel unit may be smaller than intervals between the plurality of second electrodes in the first region thereof.

The control unit may compare the sensed fingerprint with fingerprint data stored in a predetermined memory, and determine whether to enter a security mode of the touch sensing apparatus according to a comparison result.

The control unit may stop sensing the change in capacitance when the sensed fingerprint is not identical to the stored fingerprint data.

According to another aspect of the present invention, there is provided a touch sensing apparatus including: a panel unit including a plurality of touch sensing pixels in which a plurality of electrodes intersect; and an arithmetic operation unit detecting a change in capacitance generated in the plurality of touch sensing pixels and determining at least one of a touch and a fingerprint pattern, wherein the panel unit includes a first region and a second region disposed in different locations, and the plurality of touch sensing pixels included in the first region and the plurality of touch sensing pixels included in the second region have different densities.

The arithmetic operation unit may detect a change in mutual capacitance generated in the plurality of touch sensing pixels and determine at least one of the touch and the fingerprint pattern.

Densities of the plurality of touch sensing pixels included in the first region may be smaller than densities of the plurality of touch sensing pixels included in the second region.

The arithmetic operation unit may detect a change in capacitance generated in the plurality of touch sensing pixels included in the second region and determine the fingerprint pattern.

The arithmetic operation unit may detect a change in capacitance generated in the plurality of touch sensing pixels included in the first region and the second region and determine the touch when the determined fingerprint pattern is identical to fingerprint data stored in a predetermined memory.

The arithmetic operation unit may stop detecting the change in capacitance when the determined fingerprint pattern is not identical to fingerprint data stored in a predetermined memory.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of the exterior of an electronic apparatus including a touch sensing apparatus according to an embodiment of the present invention;

FIGS. 2 and 3 are plan views of touch sensing apparatuses according to embodiments of the present invention;

FIG. 4 is a cross-sectional view of the touch sensing apparatus of FIG. 2;

FIG. 5 is a flowchart illustrating an operation of a touch sensing apparatus according to an embodiment of the present invention; and

FIG. 6 is diagrams illustrating an operation of a touch sensing apparatus according to an embodiment of the present invention.

### DETAILED DESCRIPTION OF THE INVENTION

Embodiments of the present invention will be described in detail with reference to the accompanying drawings. These embodiments will be described in detail in order to allow those skilled in the art to practice the present invention. It should be appreciated that various embodiments of the present invention are different but are not necessarily exclusive. For example, specific shapes, configurations, and characteristics described in an embodiment of the present invention may be implemented in another embodiment without departing from the spirit and scope of the present invention. In addition, it should be understood that positions and arrangements of individual components in each embodiment may be changed without departing from the spirit and scope of the present invention. Therefore, a detailed description provided below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

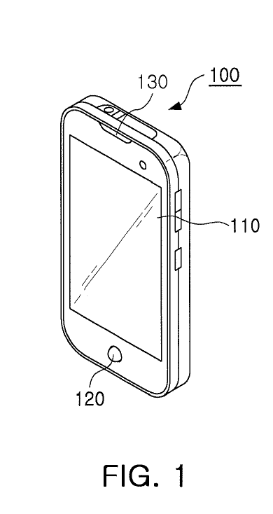

FIG. 1 is a perspective view showing an electronic apparatus to which a touch sensing apparatus according to an embodiment of the present invention is applicable. Referring to FIG. 1, an electronic apparatus 100 of the present embodiment includes a display apparatus 110 for outputting an image, an input unit 120, and an audio unit 130 for outputting audio, and may provide the touch sensing apparatus integrally formed with the display apparatus 110.

As shown in FIG. 1, in the case of a mobile apparatus, the touch sensing apparatus is integrally formed with the display apparatus 110, and thus various input methods may be provided to users in a limited form factor. The touch sensing apparatus needs to have high light transmittance enough to transmit the image displayed by the display apparatus 110. Thus, the touch sensing apparatus may be implemented by forming sensing electrodes formed of a transparent, electrically conductive material such as indium-tin oxide (ITO), indium zinc oxide (IZO), zinc oxide (ZnO), carbon nano tube (CNT), or graphene on a base substrate formed of a transparent film material such as polyethylene terephthalate (PET), polycarbonate (PC),polyethersulfone (PES),polyimide (PI), or the like. A wire pattern connected to the sensing electrodes formed of the transparent conductive material is disposed in a bezel region of the display apparatus 110, and is visually shielded by the bezel region, and thus the wire pattern may be formed of a metal material such as silver (Ag), copper (Cu), or the like.

In the case in which the touch sensing apparatus of the present embodiment may not be integrally formed with a display apparatus such as a touch pad of a notebook computer, the electronic apparatus 100 may be manufactured by simply patterning the sensing electrodes using metal on a circuit substrate. However, for convenience of description, the touch sensing apparatus and touch sensing method according to the embodiment of the present invention will now be described below on the assumption that the touch sensing apparatus is a touch screen.

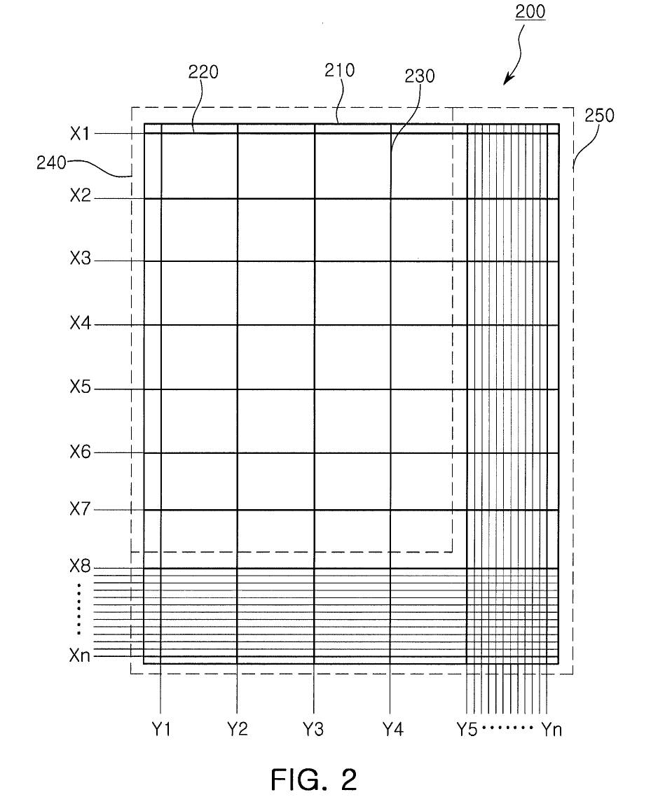

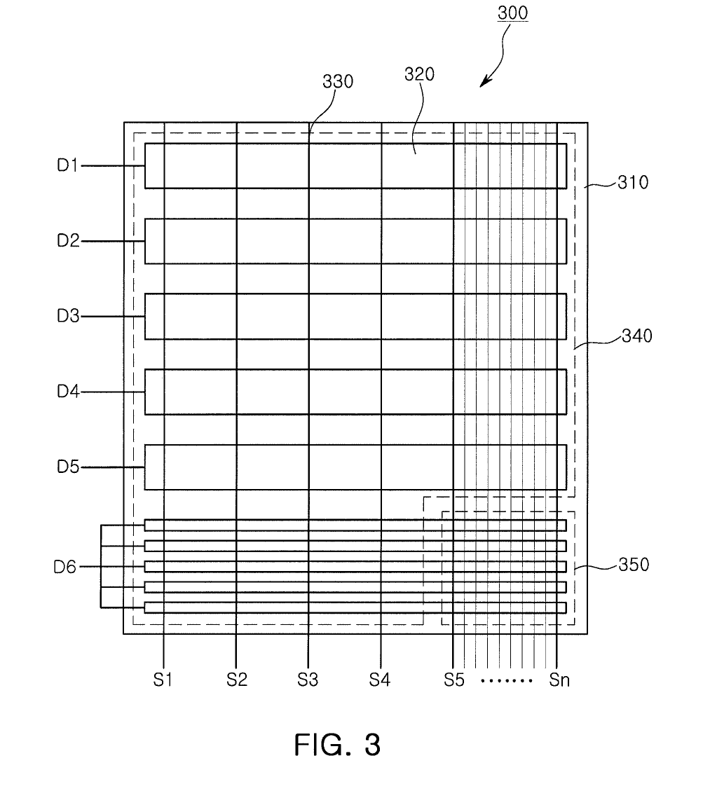

FIGS. 2 and 3 are plan views of touch sensing apparatuses according to embodiments of the present invention. Although rectangular or bar type electrodes are included in a panel unit of the touch sensing apparatus in FIGS. 2 and 3, this is merely one of the embodiments of the present invention, and the present invention is not necessarily limited thereto.

Referring to FIG. 2, a touch sensing apparatus 200 of the present embodiment includes a transparent substrate 210 and a plurality of first and second electrodes 220 and 230 disposed on the transparent substrate 210. A wire pattern electrically connected to the electrodes 220 and 230 may be disposed in a boundary of the transparent substrate 210 of the touch sensing apparatus 200. A controller integrated circuit (IC) for sensing changes in capacitance in the electrodes 220 and 230 through the wire pattern may be mounted in a circuit substrate and connected to the transparent substrate 210 but is omitted in FIGS. 2 and 3.

In FIG. 2, the first electrodes 220 extending in a first axial direction (a horizontal direction) may be electrically separated from each other and connected to sensing channels X1 to Xn of the controller IC, respectively. The second electrodes 230 extending in a second axial direction (a vertical direction) intersecting with the first axial direction may be electrically separated from each other and connected to sensing channels Y1 to Ym of the controller IC, respectively. The controller IC senses a change in capacitance by a touching object in each of the electrodes 220 and 230 and determines a touch. In particular, the controller IC may apply a predetermined driving signal to the first electrodes 220, detect a change in mutual capacitance generated from the second electrodes 230 intersecting with the first electrodes 220 to which the driving signal is applied, and determine the touch.

Intervals between the first electrodes 220 connected to the sensing channels X1 to X8 of the controller IC and intervals between the first electrodes 220 connected to the sensing channels X8 to Xn of the controller IC may be different. As shown in FIG. 2, the intervals between the first electrodes 220 connected to the sensing channels X8˜Xn may be smaller than the intervals between the first electrodes 220 connected to the sensing channels X1 to X8n. Likewise, intervals between the second electrodes 230 connected to the sensing channels Y1 to Y5 of the controller IC and intervals between the second electrodes 230 connected to the sensing channels Y5 to Ym of the controller IC may be different. As shown in FIG. 2, the intervals between the second electrodes 230 connected to the sensing channels Y5 to Ym may be smaller than the intervals between the second electrodes 230 connected to the sensing channels Y1 to Y5.

Intervals between the electrodes 220 and 230 connected some sensing channels are smaller, and thus, as shown in FIG. 2, the panel unit of the touch sensing apparatus 200 may be classified into a first region 240 and a second region 250. For convenience of description, as shown in FIG. 2, the first region 240 is defined as a region having relatively great intervals between the electrodes 220 and 230, and the second region 250 is defined as a region having relatively small intervals between the electrodes 220 and 230.

Likewise, FIG. 3 is a plan view of a touch sensing apparatus 300 according to an embodiment of the present invention. Referring to FIG. 3, the touch sensing apparatus 300 includes a transparent substrate 310, first electrodes 320 extending in a first axial direction (a horizontal direction) and electrically separated from each other, and second electrodes 330 extending in a second axial direction (a vertical direction) and electrically separated from each other. Intervals between the first and second electrodes 320 and 330 may be different in a certain region of the transparent substrate 310, similar to the embodiment of FIG. 2, so that a first region 340 and a second region 350 may be divided on the touch sensing apparatus 300.

Meanwhile, in the touch sensing apparatus 300 of FIG. 3, unlike the touch sensing apparatus 200 of FIG. 2, widths of the first electrodes 320 may be greater than widths of the second electrodes 330. Accordingly, the first electrodes 320 are disposed in a bottom surface of the transparent substrate relatively closer to a display apparatus, thereby obtaining an additional effect in a method of detecting mutual capacitance. That is, when a controller IC sequentially applies a driving signal to each of the first electrodes 320, the first electrodes 320 to which the driving signal are is applied are connected to static voltage of a ground level GND, thereby preventing electric noise generated from the display apparatus from being transferred to the second electrodes 330.

Further, in detecting a change in mutual capacitance, self-capacitance generated between the second electrodes 330 and a touching object—a person's finger—may be minimized. The self-capacitance generated between the second electrodes 330 and the touching object is in proportional to an area in which the touching object and the second electrodes 330 overlap, and thus a change in self-capacitance maybe reduced by forming the second electrodes 330 having the small widths. The change in self-capacitance is reduced while the change in mutual capacitance is maintained, thereby relatively increasing sensitivity of the change in mutual capacitance to be detected.

The first electrodes 320 are connected to driving channels D1 to D6. The second electrodes 330 are connected to sensing channels S1 to Sn. Throughout a valid sensing region of the touch sensing apparatus 300, a method of sensing a touch is defined as the method of detecting the change in mutual capacitance, and thus a method of sensing a fingerprint in the second region 350 having relatively high densities of the electrodes 320 and 330 may be also defined as the method of detecting the change in mutual capacitance.

In this regard, the first electrodes 320 having very small intervals therebetween are connected to the driving channel D6. A predetermined switching circuit unit may be included in the driving channel D6. A driving signal may be sequentially applied to the first electrodes 320 connected to the driving channel D6 through the switching circuit unit, in order to implement a resolution capable of detecting a valley and a ridge of a fingerprint when the fingerprint is sensed in the second region 350.

Meanwhile, a general touch sensing operation may simultaneously apply a driving signal to the first electrodes 320 connected to the driving channel D6. Thus, the first electrodes 320 connected to the driving channel D6 may be used for generating the change in mutual capacitance necessary for determining a touch like the first electrodes 320 connected to the other driving channels D1 to D5.

In the second electrodes 330 connected to the sensing channels S1 to Sn, densities of the second electrodes 330 connected to the sensing channels S5 to Sn included in the second region 350 of the touch sensing apparatus 300 are higher than densities of the second electrodes 330 connected to the other sensing channels S1 to S4. In this regard, intervals between the second electrodes 330 connected to the sensing channels S5 to Sn and intervals between the first electrodes 320 connected to the driving channel D6 may be determined according to a resolution necessary for detecting a fingerprint. The resolution necessary for detecting the fingerprint may be absolutely calculated with respect to the area of the second region 350.

In a general touch determination mode, an arithmetic operation unit (not shown) may disregard a change in capacitance generated in the second electrodes 330 connected to the sensing channels S6 to Sn-1. That is, the second electrodes 330 connected to the sensing channels S6 to Sn-1 are additionally prepared to obtain a resolution required for sensing a fingerprint in the second region 250, and accordingly may be disregarded in a general operation mode for determining a touch.

Further, similar to sequentially applying the driving signal to the first electrodes 320 connected to the driving channel D6 through the switching circuit unit, the second electrodes 330 connected to the sensing channels S6 to Sn may also be connected to one sensing channel through the switching circuit unit. Accordingly, the second region 350 having high densities of the first and second electrodes 320 and 330 may solve problems of an extreme increase in the number of channels of the controller IC and an increase in a chip size.

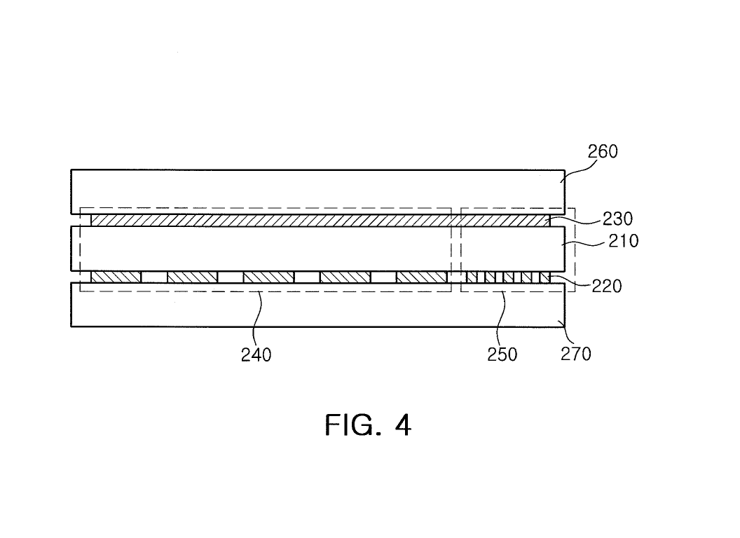

FIG. 4 is a cross-sectional view of the touch sensing apparatus 200 of FIG. 2.

Referring to 4, the touch sensing apparatus 200 may include the transparent substrate 210, the first electrodes 220, the second electrodes 230, and a cover lens 260. A display apparatus 270 may be attached to the bottom of the first electrodes 220. The first electrodes 220 and the second electrodes 230 are separately disposed in a bottom surface and a top surface of the transparent substrate 210, respectively. In this regard, on the assumption that a touch and a fingerprint are sensed from a change in mutual capacitance generated between the first and second electrodes 220 and 230, the electrodes 220 to which a driving signal is applied may be disposed in the bottom surface of the transparent substrate 210 closer to the display apparatus 270. That is, the driving signal may be applied to the first electrodes 220 in FIG. 4.

The cover lens 260 may receive a touch through at least one surface, and in particular sense a fingerprint through the second region 250. To implement a resolution required for recognizing the fingerprint in the second region 250, densities of the first and second electrodes 220 and 230 may be higher in the second region 250 than in the first region 240. To this end, intervals between the first and second electrodes 220 and 230 may be relatively small in the second region 250.

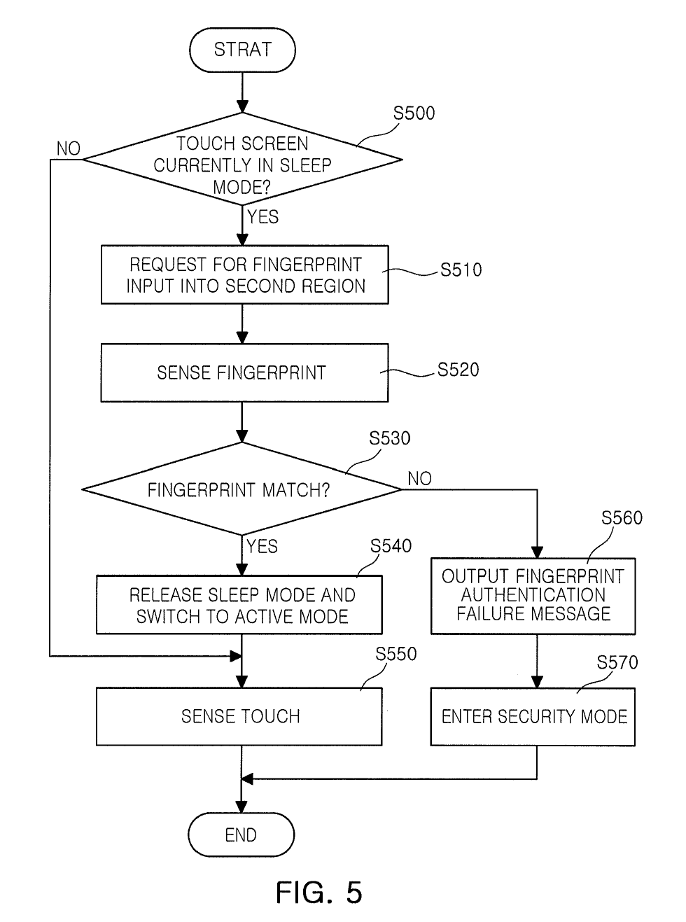

FIG. 5 is a flowchart illustrating an operation of the touch sensing apparatus 200 according to an embodiment of the present invention. As described in the embodiments of FIGS. 2 through 4, for convenience of description, the touch sensing apparatus 200 of the present embodiment is a touch screen.

Referring to FIG. 5, the operation of the present embodiment is initiated with determining whether the touch screen is currently in a sleep mode (S500). In a mobile apparatus having an environment in which a battery is frequently used, a power management of various electronic parts included in the mobile apparatus is very important, and thus the touch screen does not continuously operate in an active mode but may be switched between the sleep mode and an active mode periodically.

Further, a user can temporarily stop the operation of the touch screen intentionally when an apparatus such as a smart phone, a tablet PC is not being used. In this case, so as to activate the operation of the touch screen and the whole smart apparatus in the sleep mode, a security release procedure such as the inputting of a password or a pattern may be necessary. A fingerprint recognition sensor is integrally formed with the touch screen in the present embodiment, thereby providing a safer and easier security function than the inputting of the password or the pattern.

In the case in which it is determined that the touch screen or the mobile apparatus itself is currently in the sleep mode, when the user manipulates the mobile apparatus or applies a touch, a fingerprint input into the second region 250 is requested (S510). The second region 250 is additionally defined in a certain region of the touch screen for fingerprint recognition as described above, and may be different form the first region 240 by having different intervals between the first and second electrodes 220 and 230 or different densities thereof. As a result of determination in S500, when it is determined that the touch screen or the mobile apparatus is not currently in the sleep mode, the touch applied to the touch screen is sensed (S550), and the mobile apparatus may operate according to a user's manipulation.

When a fingerprint is input into the second region 250 according to a fingerprint input request, a controller IC of the touch screen senses the fingerprint input into the second region 250 (S520), and determines whether the input fingerprint is identical to fingerprint data stored in a predetermined memory (S530). The memory in which the fingerprint data is stored may be a USIM card of the mobile apparatus, an internal or external memory, or the like. A plurality of users may register their fingerprints as authorized users according to an owner's will of the mobile apparatus.

When it is determined that the fingerprint data stored in the memory is identical to the fingerprint input into the second region 250, the controller IC releases the sleep mode of the touch screen and informs a main controller of the mobile apparatus that a user who is currently using the mobile apparatus is a registered and authorized user. Thus, the mobile apparatus may be switched to the active mode (S540). Then, the user's touch applied to the touch screen is sensed (S550), such that the user controls the operation of the mobile apparatus.

Meanwhile, as a result of determination in S530, when it is determined that the fingerprint data stored in the memory is not identical to the fingerprint input into the second region 250, the controller IC controls the display apparatus to output a fingerprint recognition authentication failure message (S560). Further, the control IC recognizes an access of a currently unregistered user to the mobile apparatus without permission, and thus the mobile apparatus may be allowed to enter a security mode (S570). For example, the security mode may be released when a registered user's fingerprint is input or a password and a pattern is input in addition to the fingerprint input.

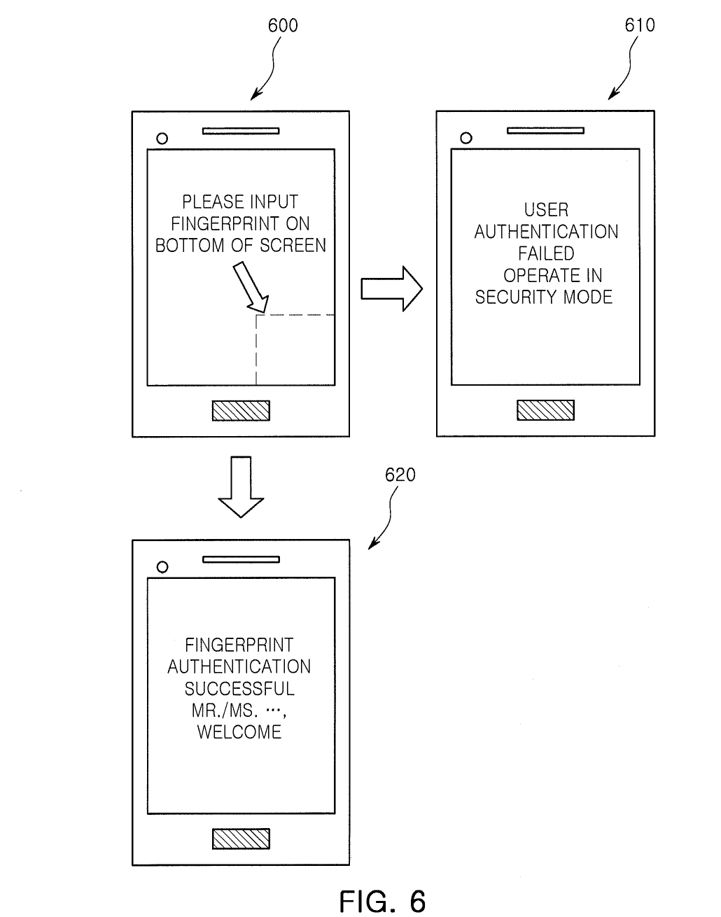

FIG. 6 is diagrams for explaining an operation of a touch sensing apparatus according to an embodiment of the present invention.

Referring to FIG. 6, a fingerprint input request message is displayed on a screen of a mobile apparatus, and a fingerprint input is requested in a certain region of the screen corresponding to the second region 250 (600). The fingerprint input request may be made during a process of releasing a power saving mode or a sleep mode when the mobile apparatus enters the power saving mode due to a long idle time or a user intentionally allows the mobile apparatus to enter the power saving mode or the sleep mode.

When the user inputs a fingerprint into the second region 250 according to the fingerprint input request, if the fingerprint input by the user is not identical to fingerprint data stored in a memory of the mobile apparatus, the mobile apparatus informs the user of a user authentication failure and operates in a security mode (610). In this regard, in consideration of an error that is likely to occur during a fingerprint recognition process, when the fingerprint recognition fails more than a predetermined number, the mobile apparatus may be set to operate in the security mode. As described above, when the mobile apparatus enters the security mode, the security mode may be released only when a registered user's fingerprint is input, or a password input, a pattern input, or the like in addition to the fingerprint input are confirmed.

Meanwhile, when the fingerprint input by the user into the second region 250 according to the fingerprint input request is identical to the fingerprint data stored in the memory of the mobile apparatus, the mobile apparatus informs the user of a user fingerprint authentication success and is switched to an active mode (620). In this regard, so as to provide a further enhanced security function, a manipulation authority of the mobile apparatus may be differently limited with respect to users by identifying users according to the fingerprint sensed in the second region 250, and differently setting an access authority for an application program of the mobile apparatus, data thereof, or the like according to the identified users.

As set forth above, according to embodiments of the invention, a panel unit is formed to have small intervals between electrodes and high densities of electrodes in a partial region of a touch sensing apparatus, and a fingerprint is sensed based on a change in capacitance generated in that region having small intervals or high densities. Accordingly, a fingerprint recognition sensor can be integrally implemented in a touch sensing apparatus without additional hardware, whereby further enhanced security performance can be provided.

While the present invention has been shown and described in connection with the embodiments, it will be apparent to those skilled in the art that modifications and variations can be made without departing from the spirit and scope of the invention as defined by the appended claims.

What is claimed is:

1. A touch sensing apparatus comprising:
a panel unit in which a plurality of electrodes intersecting with each other are disposed; and
a control unit sensing changes in capacitance generated in regions in which respective electrodes, among the plurality of intersecting electrodes, intersect,
wherein the panel unit includes a first region in which the plurality of electrodes are disposed with a first interval therebetween, and a second region in which the plurality of electrodes are disposed with a second interval therebetween, and
the control unit senses a fingerprint touching the second region based on a change in capacitance generated therein.

2. The touch sensing apparatus of claim 1, wherein the panel unit includes:
a plurality of first electrodes extending in a first axial direction and electrically separating from each other; and
a plurality of second electrodes extending in a second axial direction, intersecting with the first electrodes extending in the first axial direction, and electrically separated from each other.

3. The touch sensing apparatus of claim 2, wherein the control unit sequentially applies a driving signal to the plurality of individual first electrodes, and senses the changes in capacitance generated from the second electrodes intersecting with the first electrodes to which the driving signal is applied.

4. The touch sensing apparatus of claim 2, wherein intervals between the plurality of first electrodes in the second region of the panel unit are smaller than intervals between the plurality of first electrodes in the first region thereof.

5. The touch sensing apparatus of claim 2, wherein intervals between the plurality of second electrodes in the second region of the panel unit are smaller than intervals between the plurality of second electrodes in the first region thereof.

6. The touch sensing apparatus of claim 1, wherein the control unit compares the sensed fingerprint with fingerprint data stored in a predetermined memory, and determines whether to enter a security mode of the touch sensing apparatus according to a comparison result.

7. The touch sensing apparatus of claim 6, wherein the control unit stops sensing the change in capacitance when the sensed fingerprint is not identical to the stored fingerprint data.

8. A touch sensing apparatus comprising:
a panel unit including a plurality of touch sensing pixels in which a plurality of electrodes intersect; and
an arithmetic operation unit detecting a change in capacitance generated in the plurality of touch sensing pixels and determining at least one of a touch and a fingerprint pattern,
wherein the panel unit includes a first region and a second region disposed in different locations, and
the plurality of touch sensing pixels included in the first region and the plurality of touch sensing pixels included in the second region have different densities.

9. The touch sensing apparatus of claim 8, wherein the arithmetic operation unit detects a change in mutual capacitance generated in the plurality of touch sensing pixels and determines at least one of the touch and the fingerprint pattern.

10. The touch sensing apparatus of claim 8, wherein densities of the plurality of touch sensing pixels included in the first region are smaller than densities of the plurality of touch sensing pixels included in the second region.

11. The touch sensing apparatus of claim 10, wherein the arithmetic operation unit detects a change in capacitance generated in the plurality of touch sensing pixels included in the second region and determines the fingerprint pattern.

12. The touch sensing apparatus of claim 8, wherein the arithmetic operation unit detects a change in capacitance generated in the plurality of touch sensing pixels included in the first region and the second region and determines the touch when the determined fingerprint pattern is identical to fingerprint data stored in a predetermined memory.

13. The touch sensing apparatus of claim 8, wherein the arithmetic operation unit stops detecting the change in capacitance when the determined fingerprint pattern is not identical to fingerprint data stored in a predetermined memory.
